(19) United States
(12) Patent Application Publication
(10) Pub. No.: US 2024/0014708 A1
(43) Pub. Date: Jan. 11, 2024

(54) IN-WHEEL GENERATOR

(71) Applicants: Saietta Group PLC, Upper Heyford (GB); Consolidated Metco, Inc., Vancouver, WA (US)

(72) Inventors: Benjamin Charles Toms, Upper Heyford (GB); Stuart Robert Jones, Upper Heyford (GB); Robert Dirk Reid, Upper Heyford (GB); Steven Paul Chisolm, Upper Heyford (GB); Michael Flynn, Vancouver, WA (US); Jeff Larson, Vancouver, WA (US); Bryan Williams, Camas, WA (US); Michael Miga, Portland, OR (US); Beto Dantas, Brush Prairie, WA (US)

(21) Appl. No.: 18/215,777

(22) Filed: Jun. 28, 2023

(30) Foreign Application Priority Data
Jul. 5, 2022 (GB) 2209889.1
Jul. 8, 2022 (GB) 2210088.7

(51) Int. Cl. H02K 7/18; H02K 7/116

(52) U.S. Cl. CPC H02K 7/1846; H02K 7/116

(57) ABSTRACT

An in-wheel electrical generator for a vehicle is disclosed. The in-wheel generator comprises: a stator configured to be coupled to a non-rotating spindle of a vehicle; and a rotor configured to be indirectly coupled to a rotating hub of a vehicle. The in-wheel electrical generator is configured to be arranged outwardly of the rotating hub. A vehicle comprising such an in-wheel generator is also disclosed, along with an ancillary unit system for a trailer which uses such an in-wheel generator to power the ancillary unit.

### CROSS-REFERENCE TO RELATED APPLICATIONS

This application claims priority from United Kingdom Patent Application Number 2210088.7, filed Jul. 8, 2022, and claims priority from United Kingdom Patent Application Number 2209889.1, filed Jul. 5, 2022, which are both hereby incorporated herein by reference in their entireties.

### FIELD

The present disclosure relates to an in-wheel generator. In particular, the in-wheel generator is for supplying energy to an ancillary system of a vehicle, such as a truck or a trailer, particularly for supplying energy to, or supplementing the supply of energy to, a battery for powering an ancillary unit such as a refrigeration unit. An in-wheel generator system, and a vehicle comprising the in-wheel generator, is also disclosed.

### BACKGROUND

Electrical machines, including electric motors and electric generators, are widely used. However, concerns over our reliance on, and the pollution caused by, fossil fuel dependent internal combustion engines is increasing political and commercial pressures to extend the use of electrical machines to new applications, and to expand their use in existing ones. Electrical machines are increasingly being used in vehicles, such as electric cars, motorbikes, boats and aircraft. They are also used in energy generation, such as generators in wind turbines.

Another possible application of electrical generators is to supply energy to ancillary systems of vehicles. Electric generators may be provided as in-wheel electric generators configured to generate power as a vehicle moves.

Ancillary systems for trailers may be a suitable application for such in-wheel electrical generators. However, as such trucks and trailers typically have a double-wheel arrangement, their hubs differ significantly from hubs for electric cars and motorbikes. Thus, in-wheel generators for such vehicles typically require significant modification to standard hubs used for such trucks.

However, any modification to a standard hub may affect whether integration of an in-wheel electrical generator is economical. As such, the inventors have appreciated the need for an in-wheel generator that may be integrated into a vehicle with only minimal or no structural modification of a standard hub. Additionally, the inventors have appreciated the need for an in-wheel generator which may be retrofittable.

### SUMMARY OF DISCLOSURE

Embodiments described herein provide an in-wheel generator for a vehicle, an in-wheel generator assembly for a vehicle, a vehicle comprising an in-wheel generator assembly, and an ancillary unit system for a trailer as defined in the appended independent claims, to which reference should now be made. Preferred or advantageous features of the disclosure are set out in the dependent sub-claims.

According to a first aspect of the present disclosure, there is provided an in-wheel electrical generator for a vehicle, comprising: a stator configured to be coupled to a non-rotating spindle of a vehicle; a rotor configured to be indirectly coupled to a rotating hub of a vehicle; and a gearbox, having an input couplable to the rotating hub and an output coupled to the rotor. The in-wheel electrical generator is configured to be arranged outwardly of the rotating hub.

Advantageously, providing an in-wheel generator outwardly of the rotating hub, and coupling the rotor of the generator to the hub via a gearbox, enables the in-wheel generator to be mounted to a somewhat standard hub of a vehicle, such as a trailer. As such, the in-wheel generator can be retrofitted to a vehicle without any, or without significant, modification of the vehicle.

The terms “outward” and “outwardly” as used herein refer to an orientation relative to a vehicle to which an in-wheel generator, in use, may be coupled. In particular, outward may refer to a position which is further from the vehicle. The term “road side” may be used instead of “outward”.

Although the term “gearbox” is used throughout, it will be appreciated that any suitable type of transmission may be used. In particular, any suitable single-ratio transmission may be used.

Optionally, the in-wheel generator further comprises an outer housing configured to be directly coupled to the rotating hub and to the input of the gearbox. Providing such an outer housing advantageously both mechanically couples the rotating hub, and therefore the wheel of a vehicle, to the rotor of the generator, and protects the generator from ingress of water, dirt, and other debris.

Preferably, the gearbox is a planetary gearbox, the sun gear being coupled to the rotor, the planet gears being rotatably coupled to a stator housing, and the ring gear being coupled to the outer housing. Advantageously, utilising a planetary gearbox reduces the total volume required for the in-wheel generator while still enabling a suitable gear ratio between the input and the output.

Although the term “planetary gearbox” is used, it will be understood that any suitable epicyclic transmission may be used.

The sun gear and the planet gears are preferably rotatably coupled to an outward face of the stator housing by respective shafts. Each gear being mounted to each corresponding shaft via a bearing. The stator housing and shafts may be configured to be in thermal communication with the outer housing, preferably in thermal communication with the third housing portion.

Optionally, the gearbox is mechanically sealed. The gearbox may be mechanically sealed from the rotor and the stator and/or from bearings of the hub. By mechanically sealing the gearbox from the rotor and the stator and/or from bearings of the hub, the gearbox may be separately lubricated thus enabling the use of separate lubricants for the gearbox and the hub bearings.

Optionally, the stator housing comprises a first coupling portion configured to engage a corresponding coupling portion of a non-rotating spindle of a vehicle. The first coupling portion may comprise at least one projection configured to radially engage with at least one corresponding recess on a non-rotating spindle of a vehicle. In such an embodiment, the corresponding coupling portion comprises at least one corresponding recess. The projection, or key, is preferably provided on a shaft portion of the stator housing, the shaft portion configured to engage with, preferably in, an end of a non-rotating spindle of a vehicle. The recess, or keyway, may be provided on an internal wall of the spindle.

Alternatively, the stator housing may be configured to be coupled to a non-rotating spindle of a vehicle using a splined coupling. In such an embodiment, the first coupling portion may comprise a plurality of splines.

Optionally, the first coupling portion comprises a thread configured to engage a corresponding thread of the non-rotating spindle. Alternatively, the first coupling portion may be configured to engage a corresponding coupling portion of the non-rotating spindle of the vehicle using a pin and hole.

The coupling between the first coupling portion and the corresponding coupling portion is configured, in particular, to resist the torque from the stator. As such, providing such a coupling caters for rotation reaction torque. The coupling is also configured to radially centre the stator with the non-rotating spindle.

When provided, the outer housing preferably comprises a first housing portion configured to be coupled to the rotating hub, and a second housing portion configured to be coupled to the first housing portion and to the input of the gearbox. The outer housing is configured to enclose the stator. As will be appreciated, where a stator housing is provided, the outer housing is configured to enclose the stator housing. Optionally, the second housing portion is configured to enclose the gearbox. In that embodiment, the outer housing may further comprise a third housing portion configured to cover an outward end of the housing to enclose the gearbox. The first housing portion may be configured as an adaptor plate, and thus may be provided in a plurality of configurations to enable coupling to respective configurations of rotating hub without requiring modifying any other component. The in-wheel electrical generator may further comprise a gasket configured to provide a seal between the first housing portion and the rotating hub.

It is noted that, axially, the electrical generator is fixed by the first housing portion and its connection toward the rotating hub, wherein a length of the spindle relative to the position of the hub on the spindle is selected to ensure axial alignment.

Optionally, the gearbox is arranged outwardly of the stator and rotor. Advantageously, providing the gearbox in this arrangement enables easier access for maintenance, and does not require the in-wheel generator to be removed from the vehicle during that maintenance.

Preferably, the gearbox is configured to increase the output speed relative to the input speed. The ratio of the gearbox may be between about 3:1 and about 10:1, preferably between about 5:1 and about 7:1. In one particular embodiment, the ratio may be about 5.75:1. Advantageously, such a gearbox ratio enables the generator to operate at an efficient rotational speed over the expected range of input (i.e. wheel) rotational speeds. In one example, the maximum input rotational speed is about 630 rpm, therefore leading to a maximum output rotational speed of about 3625 rpm. The gearbox may be configured for a maximum input torque of about 72 Nm when the in-wheel generator is used with a standard trailer wheel. As such, in that particular embodiment, the maximum expected torque acting on the rotor is about 12.5 Nm.

Optionally, the in-wheel generator further comprises least one vent configured to vent to atmosphere. The vent may be provided with a breathable membrane configured to substantially prevent the ingress of water and/or dirt and debris. Advantageously, providing a vent may prevent a pressure differential between an internal pressure of the in-wheel generator and an external pressure, which could cause damage to components of the in-wheel generator.

Optionally, the in-wheel electrical generator has an outer diameter of less than 220 mm, preferably less than or equal to 200 mm, and in one embodiment the outer diameter is less than or equal to 180 mm. By providing the generator with such a maximum diameter it may be used with a substantially standard, i.e. unmodified, hub and wheel arrangement. In this manner, both the ability to retrofit and to maintain the wheel are improved.

The in-wheel electrical generator may comprise at least one temperature sensor for measuring a temperature of temperature sensitive components of the in-wheel electrical generator. In this way, the in-wheel electrical generator may be protected from damage caused by overheating.

The in-wheel generator may comprise at least one rotational position sensor. Such a position sensor may allow for improved control of the electrical generator.

According to a second aspect of the present disclosure, there is provided an in-wheel electrical generator assembly, comprising: an electrical generator as described herein; a central rotating hub; and a spindle configured to be mounted to a vehicle. The stator is coupled to the spindle, and the rotor is indirectly coupled to the central hub via the gearbox.

Advantageously, providing such an assembly enables the in-wheel generator to be mounted to a somewhat standard hub of a vehicle, such as a trailer or a truck. As such, the in-wheel generator can be retrofitted to a vehicle without any, or without significant, modification of the vehicle. In particular, providing the in-wheel generator outwardly of the rotating hub enables a wheel to be mounted and demounted to the hub without removal of the in-wheel generator.

Optionally, the spindle is a full-spindle, or axle, configured to be mounted directly to a vehicle, preferably configured to be mounted indirectly to a vehicle via a suspension arrangement. The full-spindle may be configured to have an in-wheel generator mounted on each end thereof. Alternatively, the spindle is a “half-spindle” configured to be mounted directly to a vehicle, preferably configured to be mounted indirectly to a vehicle via a suspension arrangement.

For example, a trailer may comprise two spindles carrying four in-wheel generators. In another example, a trailer may comprise three spindles carrying six in-wheel generators.

Optionally, the spindle is hollow, the assembly further comprising, or configured to be connected to, electrical wiring routed through the hollow spindle. Preferably, an outwardly facing end of the hollow spindle is configured to receive and be coupled with the stator. The electrical wiring may comprise at least one of: at least one cable for conducting electrical power from the electrical generator, preferably three cables for a 3-phase AC connection; at least one temperature sensor and/or wiring for at least one temperature sensor; electrical wires for an electrical generator rotational position sensor; electrical wires for a high voltage interlock loop (HVIL); and a grounding connection, such as a grounding wire or cable shield.

Optionally, when comprising electrical wires for a high voltage interlock loop (HVIL), the in-wheel electrical generator assembly further comprises an interlock switch configured to electrically open upon the outer housing being at least partially removed. Providing such an interlock switch enables the battery to be disconnected from an inverter of the generator, automatically, upon the outer housing being opened, e.g. for maintenance purposes. This prevents operators from being at risk of exposure to high voltages.

Optionally, the assembly further comprises, or is configured to be connected to, an automatic tyre inflation system routed through the hollow spindle.

The in-wheel electrical generator is preferably arranged for sensorless control, but may comprise, as described above, a rotational position sensor.

The hub may be configured to receive at least one standard wheel, preferably two standard wheels. The in-wheel electrical generator is particularly suited to use on a truck, or on a trailer, for powering ancillary equipment such as refrigeration units, and as such enabling one or more standard wheels reduces costs and increases usability. To enable the use of one or more standard wheels, at least one standard wheel is preferably coupled to the hub by a plurality of fasteners having a pitch circle diameter, the pitch circle diameter being greater than a diameter of the in-wheel electrical generator. In this embodiment, it is particularly preferred that each fastener is accessible without removing the in-wheel electrical generator. Advantageously, such an arrangement of diameter of the pitch circle and the in-wheel electrical generator, i.e. a relative sizing of the electrical generator to the wheel size to allow for the pitch circle diameter to be larger than the electrical machine, may facilitate easier attachment of the wheel to the central hub.

Indeed, such an in-wheel generator may allow for the largest possible generator diameter whilst still providing a standardized way of mounting a wheel (a wheel rim) to a standard hub. As generator volume correlates with power output, allowing for the largest possible generator diameter may enable the in-wheel generator to provide the maximum power possible.

An inner circle diameter of the rim opening may be larger than the diameter of the generator. Indeed, as the in-wheel generator may be housed within the inner diameter of the rim, the rim may therefore be easily removable.

Optionally, the in-wheel electrical generator assembly further comprises an electrical connector configured to be mounted to a vehicle chassis, and to electrically connect the in-wheel electrical generator to systems on the vehicle. Preferably the electrical connector is a quick-connect connector, comprising a plurality of spring-loaded connections, one for each electrical wire from the in-wheel generator. Such a connector advantageously enables the in-wheel generator assembly to be more easily retrofitted to a vehicle and/or it eases assembly.

Optionally, the electrical connector is fixed to the in-wheel-generator assembly. Such an electrical connector may be referred to as a chassis-mount connector. The chassis-mounted connector may be connectable to a wiring harness inside the spindle, which consists of a matching counter connector.

Alternatively, or additionally, both the spindle and the in-wheel generator assembly comprise a fixed connector arrangement, which comprises spring-loaded contacts configured to automatically connect when the assembly is installed.

Optionally, the in-wheel electrical generator assembly further comprises a semi-fluid grease, or other such lubricant, for use in lubricating the rotating hub and easing the sealing interface.

The in-wheel generator, and the in-wheel generator assembly, may be particularly suitable for a trailer. The in-wheel generator, and the in-wheel generator assembly, may also be suitable for a caravan; a motorhome; a truck; and a van.

According to a third aspect of the present disclosure, there is provided a vehicle comprising at least one in-wheel electrical generator assembly as described herein.

The vehicle may be one of: a trailer; a caravan; a motorhome; a truck; and a van. In particular, the vehicle may be a US class 4-8 truck in various configurations, for example a US class 6/7 truck in a 6×4 configuration, or a US class 8 truck in a 6×4 configuration, or a trailer suitable for use with such a vehicle.

When the vehicle is a trailer, it may be one of: a semi-trailer; a full trailer; a box van trailer; a curtain side trailer; a flatbed trailer; a low-loader trailer; a skeletal trailer; a moving floor trailer; a refrigerated trailer; or any suitable combination thereof.

According to a fourth aspect of the present disclosure, there is provided an ancillary unit system for a trailer comprising: at least one in-wheel electrical generator assembly as described herein; and, an ancillary unit. The in-wheel electrical generator is configured to power the ancillary unit on a trailer.

The ancillary unit system for a trailer may further comprise an electrical energy storage device, the ancillary unit being configured to be electrically coupled to the electrical energy storage device. The in-wheel electrical generator is configured to be electrically coupled to the electrical energy storage device such that, in use, electrical energy generated by the in-wheel electrical generator is stored in the electrical energy storage device. Preferably, the ancillary unit system further comprises an inverter electrically coupled between the in-wheel electrical generator and the electrical energy storage device.

The in-wheel generator is preferably a three-phase AC generator, the inverter being configured to invert the three-phase AC voltage of the in-wheel generator to a DC voltage, and therefore ensure the right amount of power will be delivered to the electrical energy storage device.

In one embodiment, the ancillary unit is a refrigeration unit but, as will be appreciated, any suitable ancillary unit provided on a trailer, or other vehicle, may be powered by the in-wheel electrical generator described herein.

The electrical energy storage device may be a battery, preferably a battery comprising a plurality of electrochemical cells. Alternatively, or in addition the electrical energy storage device may be a capacitor, or a supercapacitor.

It will be appreciated that features described in relation to one aspect of the present disclosure may also be applied equally to all of the other aspects of the present disclosure. Features described in relation to the first aspect of the present disclosure may be applied equally to the second aspect of the present disclosure and vice versa. For example, features of the drive assembly described in relation to the first aspects may be applied, mutatis mutandis, to the vehicle of the second aspect.

It will further be appreciated that particular combinations of the various features described and defined in any aspects of the invention may be implemented and/or supplied and/or used independently.

### DESCRIPTION OF SPECIFIC EMBODIMENTS OF THE DISCLOSURE

Specific embodiments of the disclosure will now be described with reference to the figures, in which:

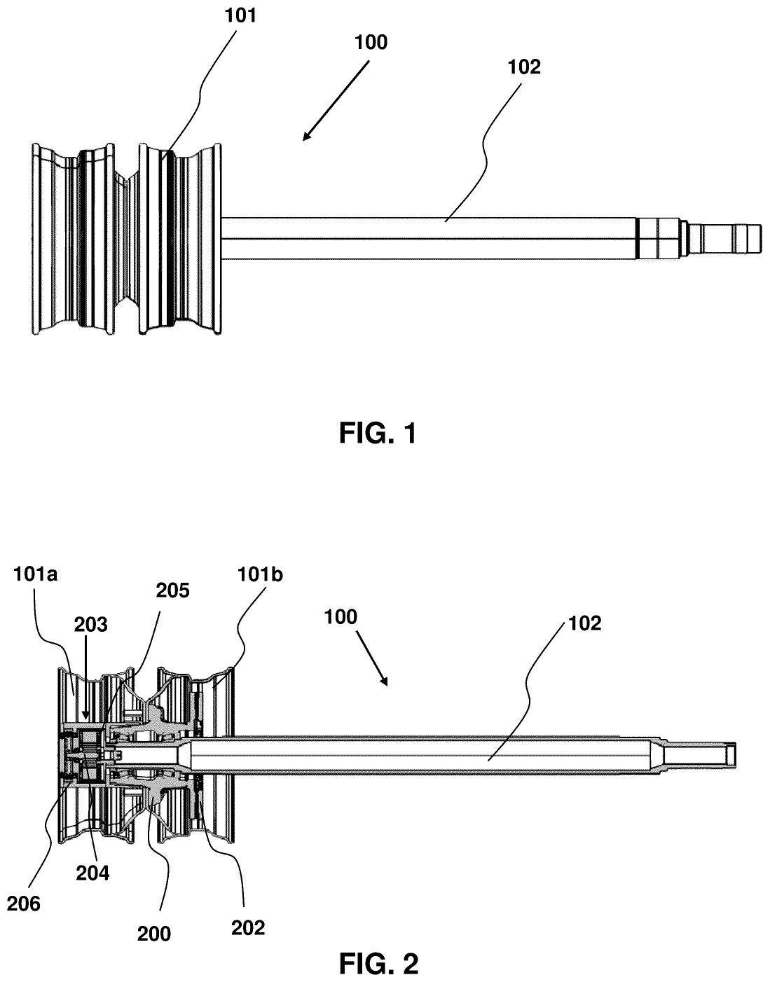

FIG. 1 shows a side view of an in-wheel electrical generator assembly;

FIG. 2 shows a cross-sectional side view of the in-wheel electrical generator assembly of FIG. 1;

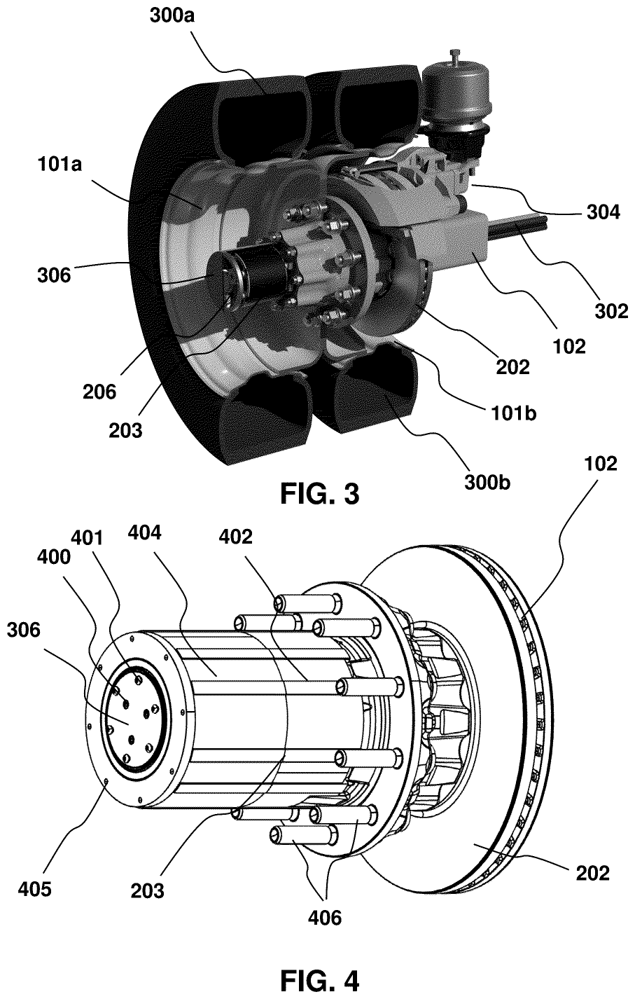

FIG. 3 shows a cross-sectional perspective view of the in-wheel electrical generator assembly of FIGS. 1 and 2, including rims, tyres, and a brake assembly of a vehicle;

FIG. 4 shows a perspective view of an in-wheel electrical generator according to the disclosure and a brake disc;

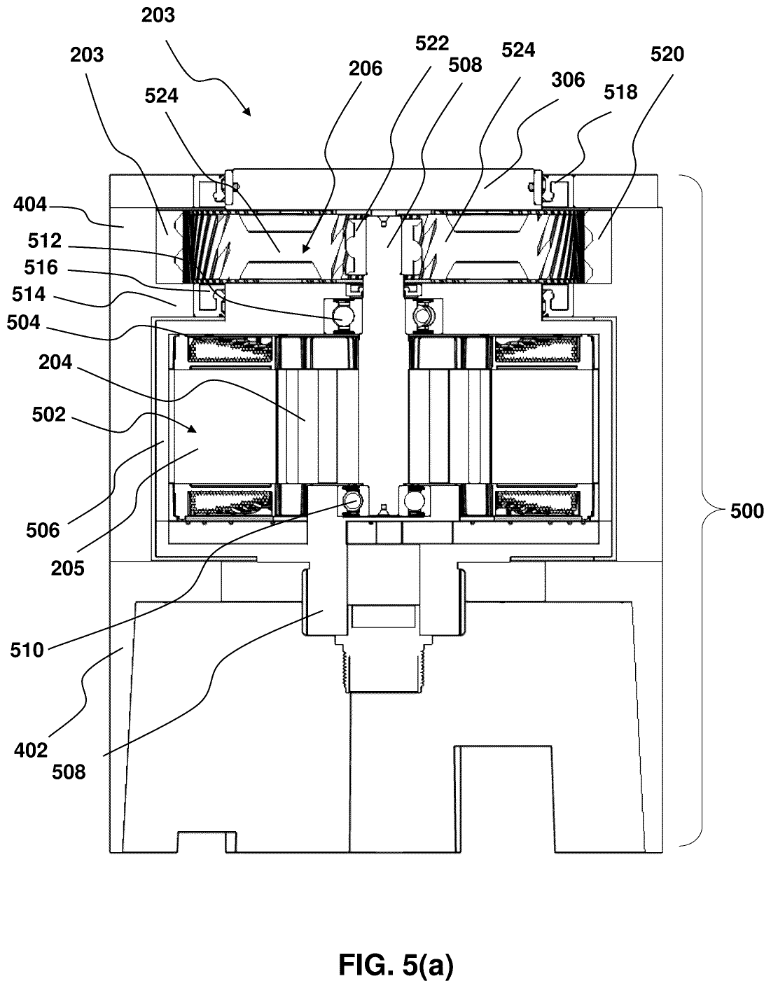

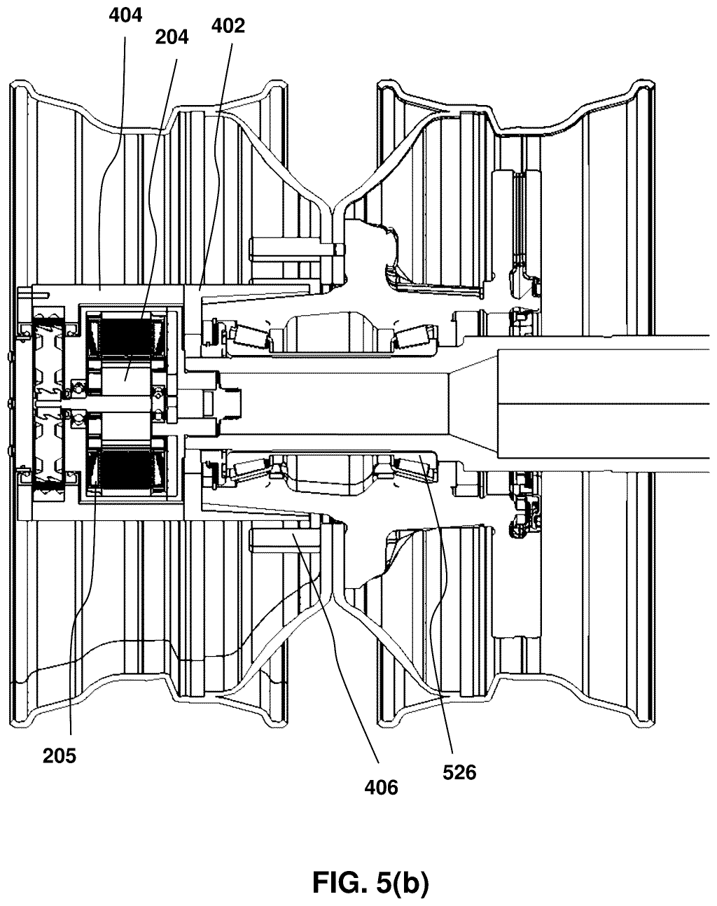

FIG. 5(a) shows a cross-sectional side view of an in-wheel electrical generator according to the disclosure;

FIG. 5(b) shows an enlarged cross-sectional side view of a part of an in-wheel generator assembly according to the disclosure, including the electrical generator shown in FIG. 5(a);

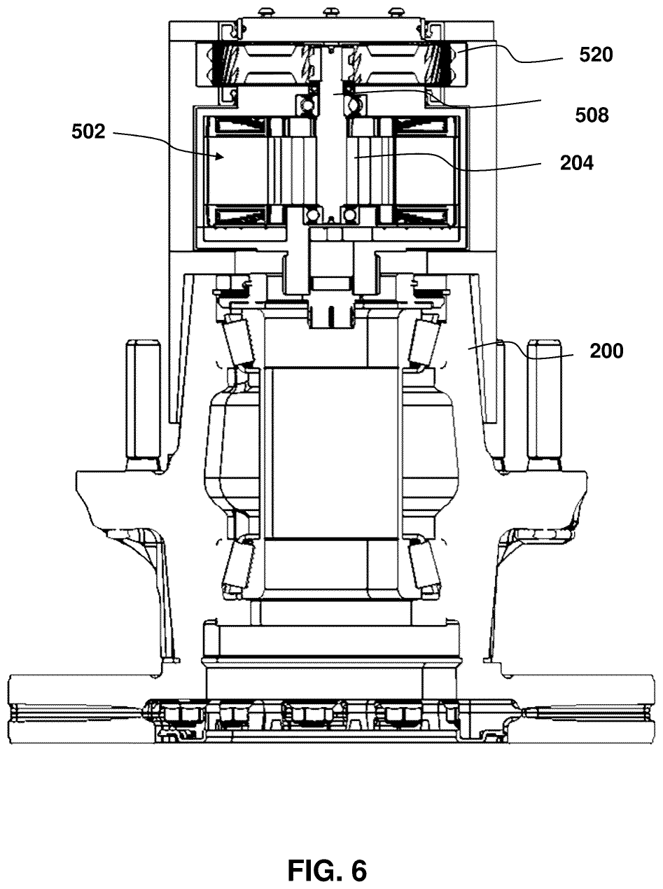

FIG. 6 shows an enlarged cross-sectional side view of an in-wheel electrical generator, according to the disclosure, coupled to a hub of a vehicle, and a brake disc;

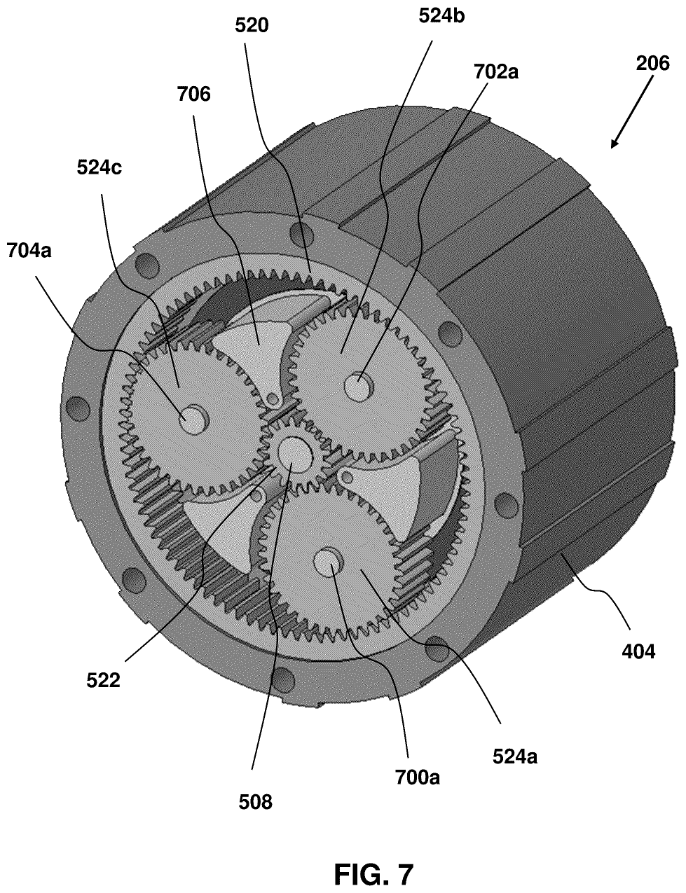

FIG. 7 shows a cross-sectional perspective view of a gearbox for an in-wheel electrical generator according to the disclosure; and

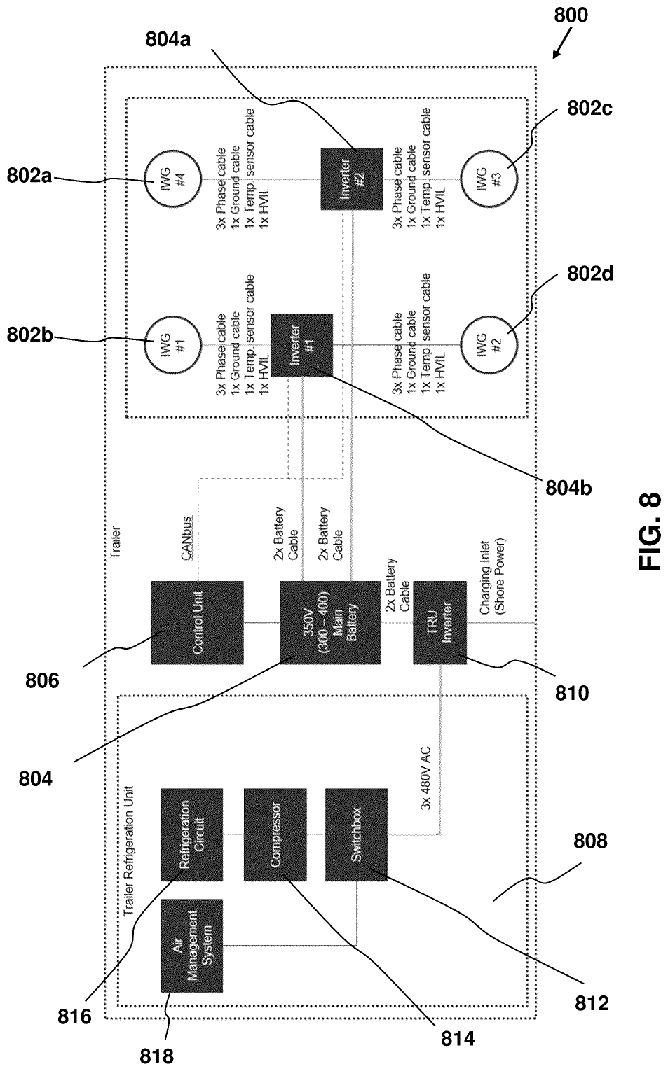

FIG. 8 shows a system diagram of an in-wheel generator system connected to an ancillary unit system.

### SPECIFIC DESCRIPTION

FIGS. 1 and 2 illustrate an example in-wheel electrical generator assembly 100, coupled to a rim assembly 101, including a spindle 102 through which electrical wiring (not shown) extends. The rim assembly 101 comprises an outward, or road-side, wheel rim 101a and an inward, or vehicle-side, wheel rim 101b.

The wheel rims are coupled to a hub 200, as will be described in more detail below. Attached to the hub 200 is a brake disc 202, which forms part of a brake assembly 304 as shown in FIG. 3.

The spindle 102 is coupled to the vehicle, via a conventional suspension system, so as to allow only limited movement relative to the vehicle as the vehicle moves, whereas the hub 200 is configured to rotate together with the wheels. A full-spindle, or axle, is shown here but it will be understood that a half-spindle may be used together with an independent suspension arrangement.

Coupled to the hub 200, outwardly, or on a road-side, thereof, and surrounded by the outward wheel rim 101a, is an in-wheel electrical generator 203. The in-wheel electrical generator 203 comprises a rotor 204 (shown in detail in FIG. 5(a)), a stator 205 (also shown in detail in FIG. 5(a)), and a planetary gearbox 206, outwardly, or on a road-side, of the rotor 204 and the stator 205. The planetary gearbox 206 is described in more detail below. In this example, the generator is an IPM (interior permanent magnet) type, and comprises a 12 slot, 8 pole electromagnetic arrangement. However, of course, it will be understood that any suitable type of generator may be used. The generator in this example is configured to output 5 kW maximum, 3.5 kW continuous, power.

As shown in FIG. 3, the wheel rims 101a, 101b, carry respective tyres 300a, 300b for engaging a road surface.

Also, as shown in FIG. 3, routed within the spindle 102 are cabling 302. The cabling 302 includes electrical wiring for taking electrical power generated by the electrical generator to systems on the vehicle. The spindle 102 extends through a central cavity of the hub 200, allowing the cabling 302 to pass from a road side of the hub 200 to a vehicle side of the hub 200.

The hub 200 is a standardized hub for a trailer of a truck, in particular for a trailer having an ancillary unit system, such as a trailer refrigeration unit. The cabling 302 allows for electrical power (for the in-wheel electric generator 203, for temperature and position sensors, and for HVIL and grounding) to flow from a vehicle side of the hub 200 to a road side of the hub 200, and vice versa.

At the outward, or road-side, end of the gearbox 206, a cover 306 is provided. The cover 306 is removable so as to allow access to an interior of the gearbox 206 and/or an interior of the electrical generator 203. Shown in detail in FIG. 4, the cover 306 is removably attached to the gearbox 206 with fasteners 400. The cover 306 further comprises apertures 401 which may improve heat dissipation.

As shown in FIG. 4, the in-wheel electric generator 203 comprises an outer housing which comprises a first housing portion 402 which is coupled to the rotating hub 200, and a second housing portion 404 which is coupled to the first housing portion 402 and to the gearbox 206. A further housing portion 405, coupled outwardly to the second housing portion 404, and the cover 306 form a third housing portion, the third housing portion completing the outer housing of the generator.

FIG. 5(a) shows a cross-sectional view of an in-wheel electrical generator 203 as described above. As described herein, the in-wheel electrical generator 203 comprises an outer housing 500. The outer housing 500 comprises a first housing portion 402, configured to be directly coupled by means of fasteners to an outer face of the rotating hub 200, a second housing portion 404, configured to be coupled by means of fasteners to the first housing portion 402, and a third, cover, portion 306.

The first housing portion 402 may be referred to as an adapter plate, as the first housing portion 402 may be adapted to the standard hub 200 to which the in-wheel electrical generator 203 is coupled. There is a gasket (not shown) between the first housing portion 402 and the hub 200 to seal the coupling.

The outer housing 500 is configured to house the stator 205 which is formed of a stator assembly 502 made up of an arrangement of conductive coils 504, and a stator housing 506. The stator housing 506 comprises a portion 508 configured to be coupled to the road-side end of the spindle 102. The road-side end of the spindle 102 comprises a keyway (not shown) for radially fixing the stator 205 to the spindle 102. The portion 508 comprises a key configured to engage with the keyway.

The rotor 204, having permanent magnets, is provided within the stator 205. The rotor 204 is supported by a rotor shaft 508, which is supported by an inward bearing 510 and an outward bearing 512, both mounted in the stator housing 506.

As can be seen, an annular flange 514 is provided which partially encloses one end of the stator housing 506. The annular flange 514 enables a seal 516 to be provided to seal the gap between an outer radial surface of the stator housing 506 and the annular projection 514. The annular flange 514 and the seal 516 therefore act to seal and mechanically separate the gearbox 206 from the stator 205 and rotor 204. A similar seal 518 is provided at the third, cover, portion 306 to seal the gearbox 206 from the external environment.

The planetary gearbox 206 comprises an input ring gear 520 (also shown in FIG. 7) which is coupled to the rotating hub 200 via the second housing portion 404 (and the first housing portion 402), and an output sun gear 522 which is coupled to the rotor shaft 508. The input ring gear 520 is coupled to the output sun gear 522 by three planet gears 524 (only two shown). The planet gears 524 are mounted on shafts (shown in FIG. 7), via bearings, the shafts being integral with an outer face of the stator housing 506.

Looking now to FIG. 5(b), the in-wheel generator 203 can be seen coupled to a rotating hub, and the wheels rims, in turn, coupled to the hub. As can be seen, the spindle 102 is provided within the inner thrust bearings 526 of the hub.

The wheel rims 101a, 101b are attached to the hub 200 by fasteners 406 arranged at a pitch circle diameter about the hub 200. The relative diameter of the in-wheel electric generator 203 and the pitch circle diameter of the fasteners 406 are selected such that the fasteners 406 may be fastened to attach the rims to the hub 200 from a road-side.

Although the outside diameter of the stator housing in this embodiment is about 180 mm, the stator housing may have a larger outside diameter. The maximum outside diameter is less than 220 mm, as the limiting factor, e.g. for a trailer, is an inner rim diameter of the wheel rims 101a, 101b may be about 220 mm.

Looking now to FIG. 7, a detailed view of the planetary gearbox. Rotation of the second housing portion 404 is transmitted to the gearbox 206 via a ring gear 520 of the gearbox 206. The ring gear 520 is coupled to three planet gears 524a, 524b, 524c, which in turn are coupled to a sun gear 522. Each planet gear 524a, 524b, 524c is rotatably mounted to the stator housing by respective shafts 700a, 702a, and 704a. The shaft of the sun gear 522 is coupled to the rotor shaft 508, thus coupling the gearbox 206 to the rotor 204.

Also shown in FIG. 7, blocks 706 are provided to put the stator in thermal communication with the outer housing cover portion 306 and thereby increase the ability for the generator to dissipate heat to the environment. The configuration of the blocks 706 also improve the lubrication of the planet gears 524a, 524b, 524c.

The planetary gearbox 206 is arranged to increase the rotational output speed of the gearbox 206 relative to the rotational input speed. The rotational output speed of the gearbox 206 may be increased by a ratio of about 5.75:1 relative to the rotational input speed.

FIG. 8 shows a system diagram of a vehicle 800, comprising four in-wheel generators 802a-d, each pair of in-wheel generators 802a-d being connected to a respective inverter 804a,b by wiring, which respectively includes three phase cables, one ground cable, a temperature sensor cable and a high voltage interlock loop (HVIL) cable.

The vehicle 800 comprises an electrical energy storage device, i.e. battery 804 comprising electrochemical cells, to which the inverters are connected. A control unit 806 controls the battery and the inverters 804a,b. A trailer refrigeration unit (TRU) 808 is electrically connected to the battery 804 via a further inverter 810.

The TRU 808 comprises a switchbox 812, a compressor 814, and a refrigeration circuit 816. The switchbox is also connected to an air management system 818 of the TRU 808.

Although the vehicle 800 in this example is a refrigerated trailer having a TRU 808, it will be apparent to those skilled in the art that an in-wheel generator, and an in-wheel generator assembly, according to the disclosure may be used to power any ancillary component or system of a vehicle or a trailer. Indeed, the vehicle may not be a trailer, but may instead, for example, be a truck, and the number of inverters and in-wheel generators may differ depending on the application.

1. An in-wheel electrical generator for a vehicle, the in-wheel electrical generator comprising:
a stator configured to be coupled to a non-rotating spindle of a vehicle;
a rotor configured to be indirectly coupled to a rotating hub of a vehicle; and
wherein the in-wheel electrical generator is configured to be arranged outwardly of the rotating hub.

2. The in-wheel electrical generator of claim 1, further comprising a gearbox having an input couplable to the rotating hub and an output coupled to the rotor.

3. The in-wheel electrical generator of claim 2, further comprising an outer housing configured to be directly coupled to the rotating hub and to the input of the gearbox.

4. The in-wheel electrical generator of claim 3, wherein the gearbox is a planetary gearbox, the sun gear being coupled to the rotor, the planet gears being rotatably coupled to a stator housing, and the ring gear being coupled to the outer housing.

5. The in-wheel electrical generator of claim 4, wherein the stator housing comprises a first coupling portion configured to engage a corresponding coupling portion of a non-rotating spindle of a vehicle.

6. The in-wheel electrical generator of claim 5, wherein the first coupling portion comprises at least one projection configured to radially engage with at least one corresponding recess on a non-rotating spindle of a vehicle.

7. The in-wheel electrical generator of claim 3, wherein the outer housing comprises a first housing portion configured to be coupled to the rotating hub, and a second housing portion configured to be coupled to the first housing portion and to the input of the gearbox, wherein the outer housing is configured to enclose the stator.

8. The in-wheel electrical generator of claim 2, wherein the gearbox is arranged outwardly of the stator and rotor.

9. The in-wheel electrical generator of claim 2, wherein the gearbox is configured to increase the output speed relative to the input speed.

10. The in-wheel electrical generator of claim 9, wherein the ratio of the gearbox is between about 3:1 and about 10:1.

11. The in-wheel electrical generator of claim 2, wherein the gearbox is mechanically sealed from the rotor and the stator.

12. The in-wheel electrical generator of claim 1, further comprising a least one vent configured to vent to atmosphere.

13. The in-wheel electrical generator of claim 1 having an outer diameter of less than 220 mm.

14. An in-wheel electrical generator assembly comprising:
the in-wheel electrical generator of claim 1,
a central rotating hub; and
a spindle configured to be mounted to a vehicle,
wherein, the stator is coupled to the spindle, and the rotor is connected to the central hub.

15. The in-wheel electrical generator assembly of claim 14, wherein the spindle is hollow, the assembly further comprising electrical wiring routed through the hollow spindle.

16. The in-wheel electrical generator assembly of claim 15, wherein an outwardly facing end of the hollow spindle is configured to receive and be coupled with the stator.

17. The in-wheel electrical generator assembly of claim 15, wherein the electrical wiring comprises at least one of:
at least one cable for conducting electrical power from the electrical generator;
at least one temperature sensor and/or wiring for at least one temperature sensor; and
electrical wires for an electrical machine rotational position sensor; and
electrical wires for a high voltage interlock loop; and
a grounding connection.

18. The in-wheel electrical generator assembly according to claim 17, wherein the electrical wiring comprises the electrical wires for the high voltage interlock loop, the in-wheel electrical generator assembly further comprising an interlock switch configured to open upon the outer housing being at least partially removed.

19. The in-wheel electrical generator assembly of claim 14, wherein the hub is configured to receive at least one wheel.

20. The in-wheel electrical generator assembly of claim 19, wherein the at least one wheel is coupled to the hub by a plurality of fasteners having a pitch circle diameter, the pitch circle diameter being greater than a diameter of the in-wheel electrical generator.

21. The in-wheel electrical generator assembly of claim 20, wherein each fastener is accessible without removing the in-wheel electrical generator.

22. The in-wheel electrical generator assembly of claim 14, further comprising an electrical connector configured to be mounted to a vehicle chassis, and to electrically connect the in-wheel electrical generator to systems on the vehicle.

23. A vehicle comprising at least one in-wheel electrical generator assembly of claim 14.

24. An ancillary unit system for a trailer, the ancillary unit system comprising:
at least one in-wheel electrical generator assembly of claim 14; and,
an ancillary unit, wherein said in-wheel electrical generator is configured to power the ancillary unit on a trailer.

25. The ancillary unit system of claim 24, further comprising an electrical energy storage device, the ancillary unit being configured to be electrically coupled to the electrical energy storage device, wherein, the in-wheel electrical generator is configured to be electrically coupled to the electrical energy storage device such that, in use, electrical energy generated by the in-wheel electrical generator is stored in the electrical energy storage device.

26. The ancillary unit system of claim 25, further comprising an inverter electrically coupled between the in-wheel electrical generator and the electrical energy storage device.
